(19) United States
(12) Patent Application Publication
(10) Pub. No.: US 2006/0064375 A1
(43) Pub. Date: Mar. 23, 2006

(54) Method and system for creating and maintaining records of title for items of property

(75) Inventors: Matthew J. Campagna, Ridgefield, CT (US); Deepak Chopra, Harpenden (GB); Leon A. Pintsov, West Hartford, CT (US)

Correspondence Address: Pitney Bowes Inc.;Intellectual Property & Technology Law Department, 35 Waterview Drive, P.O. Box 3000, Shelton, CT, 06484, US

(73) Assignee: Pitney Bowes Incorporated, Stamford, CT (US)

(21) Appl. No.: 10/945,320

(22) Filed: Sep. 20, 2004

(51) Int. Cl. G06Q 40/00

(52) U.S. Cl. 705/39

(57) ABSTRACT

A method and system for recording a transaction affecting title to an identified item of property and for maintaining a record of title for such item of property. The system includes a title security device and a title record management system. The title security device includes: a) input means to the device for input of transaction information relating to a transaction; b) a data store storing a signing key for digitally signing documents; and c) a programmable controller communicating with the title record management system. The controller is programmed to control the title recording system to: a) input the transaction information; b) generate a document representative of changes in the title resulting from the transaction; and c) digitally sign the document with the signing key. The title record management system includes: a) a database, the database including an initial record for the item of property; and b) a programmable record system controller communicating with the title security device. The record system controller is programmed to control the title record management system to: a) receive a digitally signed document representative of changes in the title resulting from the transaction; b) verify the document's signature; and c) update the record of title for the item of property in accordance with the document if the signature is determined to be valid.

### BACKGROUND OF THE INVENTION

The subject invention relates to creation and maintenance of records of title for items of property. More particularly, it relates to the creation title documents evidencing a transaction which transfers or creates a lien, or other encumbrance of title to an identified item of property and the creation and updating of records of title which reflect such transactions.

Transfer of title, particularly title to real estate, is a complex and expensive process typically requiring extensive manual searching of paper files to assure the seller's title is good and to determine if liens or other encumbrances of title exist. This problem is exacerbated by new forms of secured transactions such as home equity lines of credit where the amount secured may increase from time to time; possibly requiring additional searches for senior liens, e.g., tax liens.

The problem in regard to personal property is even greater. In many cases, no proof of ownership other than physical possession exists; while putatively authenticated title documents, such as automobile titles, are easily copied or forged and fraudulently used to secure multiple loans. This situation limits availability and increases the costs of loans secured by personal property.

Thus, it is an object of the subject invention to provide a method and system for the creation and updating of records of title which can be promptly and securely accessed to determine the holder of, and any encumbrances on, the title to an identified item of property.

### SUMMARY OF THE INVENTION

The above object is achieved and the disadvantages of the prior art are overcome in accordance with the subject invention by a method and system operating in accordance with that method to record a transaction affecting title to an identified item of property by: a) inputting transaction information relating to the transaction to a title security device, the device storing a signing key for digitally signing documents; b) controlling the device to generate a document representative of changes in the title resulting from the transaction; and c) controlling the device to digitally sign the document with the signing key.

In accordance with one aspect of the subject invention, the document is an electronic document.

In accordance with another aspect of the subject invention the document is a printed document.

In accordance with another aspect of the subject invention a copy of the document is provided to a tax authority. By “tax authority’ herein is meant any governmental or other agency which collects a tax or other charge based upon the transaction.

In accordance with another aspect of the subject invention, the device is controlled to compute a tax amount due with regard to the transaction, and the document includes the amount.

In accordance with another aspect of the subject invention, the device communicates with an escrow account system to cause the amount to be paid to the tax authority.

In accordance with another aspect of the subject invention, a copy of the document is sent to a title recording system.

In accordance with another aspect of the subject invention, the title recording system verifies the document's signature and updates a record of title for the item of property in accordance with the document if the signature is determined to be valid.

In accordance with another aspect of the subject invention, the device requests and receives a copy of a record of title for the item and provides at least one party to the transaction with information from the record of title before completion of the transaction.

In accordance with another aspect of the subject invention, the transaction includes transfer of title to the item of property.

In accordance with another aspect of the subject invention, the transaction includes creation of a lien against the item of property.

In accordance with still another aspect of the subject invention a record of title for an item of property is maintained by: a) establishing a title recording system, the title recording system including a database, the database including an initial record for the item of property; b) controlling the title recording system to receive a digitally signed document representative of changes in the title resulting from a transaction; c) controlling the title recording system to verify the document's signature; and d) controlling the title recording system to update the record of title for the item of property in accordance with the document if the signature is determined to be valid.

In accordance with another aspect of the subject invention, the record of title is maintained by, prior to step b described above: a) controlling the title recording system to receive a request for a copy of the record of title from a title security device; and b) returning the copy to the device.

In accordance with another aspect of the subject invention, the request is digitally, signed and the record of title is maintained by: a) controlling the title recording system to verify the request's signature; and b) controlling the title recording system to return the copy of the record of title only if the signature is determined to be valid.

Other objects and advantages of the subject invention will be apparent to those skilled in the art from consideration of the detailed description set forth below and the attached drawings.

### BRIEF DESCRIPTION OF THE DRAWINGS

FIG. 1 shows a block diagram of a system in accordance with the subject invention.

FIG. 2 shows a flow diagram of the operation of the system of FIG. 1 in creating or updating a record of title to an item of property in accordance with the method of the subject invention.

FIG. 3 shows a flow diagram of the operation of the system of FIG. 1 in creating a record of a lien, or other encumbrance of title, on an item of property in accordance with the method of the subject invention.

### DETAILED DESCRIPTION OF PREFERRED EMBODIMENTS OF THE INVENTION

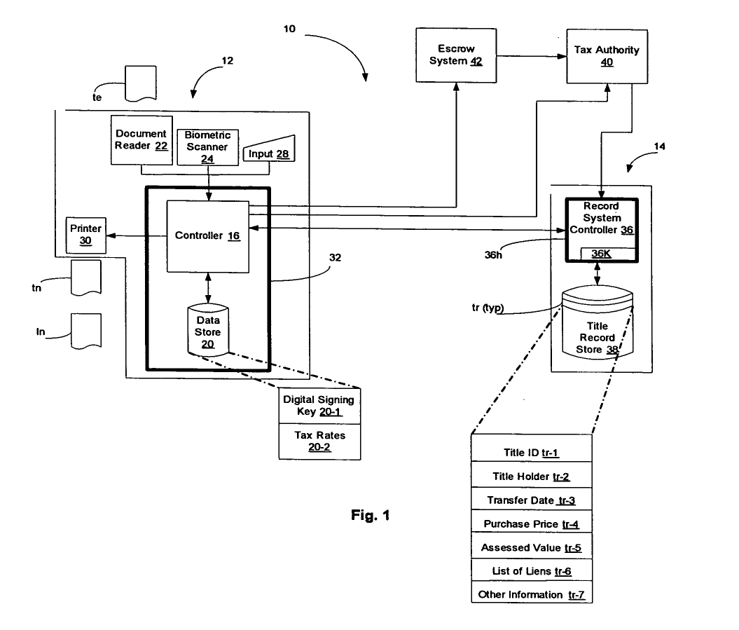

FIG. 1 shows a preferred embodiment of the invention where system 10 includes title security device 12 (hereinafter sometimes TSD 12) for the creation title documents and title record management system 14 (hereinafter sometimes TRMS 14) for the creation and updating of records of title.

TSD 12 includes controller 16, which is programmed in accordance with the method of the subject invention, and data store 20 which stores digital signing key, and corresponding certificate 20-1 and, in a preferred embodiment, tax rates 20-2 for determining taxes due on transactions relating to property titles. Controller 16 communicates with document reader 22 for reading existing title documents te (and possibly other documents), optical biometric scanner 24 for scanning biometric characteristics of parties to transactions to verify their identities, data input 28 for input of data describing transactions, and printer 30 for printing new title documents tn or lien documents ln. (As used herein the terms “title document” and “lien document” can refer to documents in either electronic or printed form. While the electronic and printed forms of these documents are consistent, an exact one-to-one correspondence is not required by the subject invention.) Preferably, controller 16 and data store 20 are enclosed in secure housing 32 or are protected in any other convenient manner to prevent unauthorized access.

TSD 12 communicates with TRMS 14 both to obtain title reports prior to completion of transactions and to return new title documents for recordation, as will be described further below. TRMS includes record system controller 36 and title record store 38 for storing title records tr. Preferably reports tr are digitally signed or encrypted to prevent unauthorized alteration, and controller 36 is enclosed in secure housing 36h or is protected in any other convenient manner to prevent unauthorized access.

Preferably records tr include fields:
a) Title ID tr-1—a unique, system wide identifier;
b) Current Title Holder(s) tr-2;
c) Last Transfer Date tr-3;
d) Last Purchase Price tr-4;
e) Assessed Value tr-5;
f) List of Liens tr-6 (identified by :)
   i) Transaction ID—a unique, system wide identifier of the transaction creating the lien;
   ii) Lien ID—a unique, system wide, lien identifier;
   iii) Lien Amount—can vary depending on current level of debt;
   iv) Lien Holder
   v) Lien Date
g) Other Information tr-7

In a preferred embodiment of the invention, TSD 12 communicates tax amounts due to tax authority 40 through escrow system 42; where the operator of TSD 12 (hereinafter sometimes referred to as a notary) maintains an account. In this embodiment, the operator collects taxes fees or other amounts due from a party to the transaction and remits the amounts due to authority 40 through system 42. System 42 can be an automated system such as the postage meter escrow system operated by the assignee of the subject invention under the service mark “Postage-by-Phone” or can wholly or partly be a manual system, or can be operated in any other convenient manner; details of which form no part of the subject invention. In another embodiment, tax amounts and other necessary information are communicated directly to authority 40 for collection.

In another embodiment of the subject invention, tax authority 40 communicates directly with record system controller 36. Controller 36 is programmed to automatically create liens for the amount of taxes due on an identified item of property in response to a request communicated from authority 40, as will be described further below.

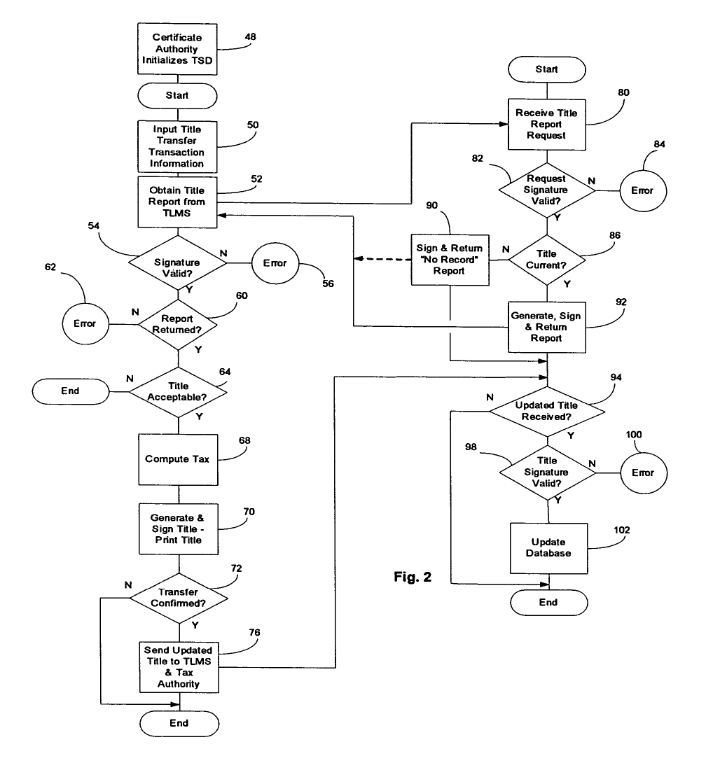

Turning to FIG. 2, a flow diagram of the operation of system 10 in creating a record of the transfer of title to a particular item of property is shown. Steps 50 through 76 show the operation of TSD 12, and steps 80 through 102 show the concurrent operation of TRMS 14. At step 48, TSD 12 is manufactured or otherwise provided under the auspices of a central authority which operates TRMS 14 and which can be a traditional certificate authority. The central authority has a public key pair for signing communications from TRMS 14 (Sign_{CA}, Verify_{CA}) and a certificate C(Verify_{CA})_{CA}. TSD 12 is initially provided with the central authority's certificate C(Verify_{CA})_{CA} and creates its own public key signing pair (Sign_{TSD}, Verify_{TSD}) and will obtain a certificate for its public, verifying key C(Verify_{TSD})_{CA}. Preferably, certificate C(Verify_{TSD})_{CA} is an implicit certificate to reduce the portion of a signed document which must be machine-readable. The private, signing key portions of the signing key pair (Sign_{CA}, Verify_{CA}) are stored in the secure portion 36K of Record System Controller 36. (Public key signing of documents is a cryptographic technique using a verification key for assuring that a document has been received from a party who processes a corresponding signing key, and certification is a technique for providing assurance by a trusted third party that a party distributing a verification key is correctly representing itself. These techniques are well-known to those skilled in the art and need not be discussed further here for an understanding of the subject invention.)

Typically, a notary will purchase, lease or otherwise obtain TSD 12 from a central authority or a vendor authorized by a central authority. Preferably, assignment of TSD 12 to a particular notary will be recorded and cryptographically bound by the central authority or a registration authority responsible to the central authority.

Once TSD 12 is initialized and in the procession of a notary, parties wishing to transact and record a transfer of title to an identified piece of property can use system 10 to do so. Then, at step 50, TSD 12 inputs transaction information relating to transfer of title for an identified item of property. Typically, transaction information for a transfer of title can include:
a) Buyer's Name(s) and Other Identifying Information
b) Seller's Name(s) and Other Identifying Information
c) Property Description/Identification
d) Terms of Transfer (e.g. subject to mortgage lien, easement, etc.)
e) Date of Sale

In a preferred embodiment, this information can be input to controller 16 from one or more documents, which can include a seller's existing title document te, through document reader 22. In a preferred embodiment, these documents are digitally signed with:
f) Buyer's Digital Signature and Certificate
g) Seller's Digital Signature and Certificate
   which are verified by TSD 12.

In another preferred embodiment the transaction information includes:
h) Biometric Information identifying the Buyer or Seller
   The biometric information is input through biometric scanner 24 and can be a digitized finger print scan, a digitized hand-written signature or any other convenient biometric or person characteristic information. The biometric information can be verified to authenticate the identities of the buyer or seller by comparison with scanned identity documents submitted with the transaction information (which can be a title document) or in any other convenient manner.

Preferably the transaction information will include:
i) Title Identification
   which is designed to be a unique system wide identifier for the title of the item of property to be transferred. The title identifier can be read from existing title document te or supplied by the seller.

Preferably TSD-12 then augments the transaction information with:
j) Notary Name and Information
k) Notary ID; and
l) Transaction ID

In other embodiments of the invention some or all of the above information is confirmed in any convenient manner by the notary and input manually through input 28.

Then at step 52, controller 16 obtains a title report; as will be described further below with respect to the operation of TRMS 14. At step 54, controller 16 confirms that the returned report is properly signed with signing key Sign_{CA} by TRMS 14, and if not, goes to an error routine at step 56. (Note that the error routine of step 56, and other error routines described hereinafter, form no part of the claimed invention and need not be described further here for an understanding of the subject invention.)

Then at step 60, controller 16 determines if a title report was returned by TRMS 14. If not, then controller 16 goes to an error routine at step 62. Otherwise, at step 64, controller 16 determines if the title is acceptable to complete the transaction. If it is not, the program ends. Otherwise, at step 68, controller 16 accesses tax rates 20-2 in data store 20 and computes any taxes owed on the transfer of title.

At step 70, TSD 12 generates, digitally signs, and prints new title document tn which can include some or all of the transaction information described above in a two-dimensional barcode format, or any other convenient machine readable format, to facilitate further transactions relating to that title. Then at step 72, controller 16 determines if the transfer of title is confirmed, i.e., if the necessary formalities necessary to complete the transfer have been carried out. Typically, these formalities can include proof that any taxes owed in regard to the transaction have been paid. This determination can be made based on input by the notary who has witnessed the formal transfer or in any other convenient manner. If the transfer is not confirmed, the program ends. Otherwise, at step 72, controller 16 sends an updated, electronic title document to TRMS 14 and to tax authority 40 to create a tax audit record for government purposes. In another embodiment of the subject invention, the notary can collect the taxes due, and controller 14 directs escrow system 42, typically managed by the notary, to pay the taxes to authority 40. The program then ends.

At step 80, TRMS 14 receives a request for a title report generated by TSD 12 at step 52. The title can be identified by the unique title identification described above or can be identified by matching with other transaction information (e.g., seller's name, property description). Then at step 82, record system controller 36 determines if the request has been validly signed by TSD 12, and if has not, goes to an error routine at step 84. Otherwise, at step 86, controller 36 determines if a current record of title is stored in title record store 38, and if it is not, then at step 90, generates and digitally signs a “No Record” report and returns it to TSD 12 at step 52.

Otherwise, at step 92, controller 36 generates, digitally signs, and sends an electronic copy of title report tr to TSD 12 at step 52. Preferably, report tr includes:
a) Title ID tr-1
b) Current Title Holder tr-2
c) Last Title Transfer Date tr-3
d) Last Purchase Price tr-4
e) Current Assessed Value tr-5
f) List of Liens tr-6
g) Other Information as may be found useful tr-7
   Each listed lien preferably includes:
i) Transaction ID
ii) Lien ID
iii) Lien Amount/Description
iv) Lien Holder
v) Lien Date
   Controller 36 then digitally signs report tr before sending it to TSD 12.

(As used hereinafter, the term “lien” is intended to include other encumbrances of title, such as easements and restrictions.)

Then at step 94, controller 36 determines if an updated title is received from TSD 12. If, because of a timeout condition or because TSD 12 sends a signal canceling the transaction in the course of an error routine, or for any other indication that the title will not be changed, controller 36 determines that the title will not change, the program ends. Otherwise at step 98, controller 36 determines if the updated title has been validly signed by TSD 12, and if it has not, goes to an error routine at step 100. Otherwise, at step 102, controller 36 updates the title record in accordance with the updated title. The program then ends.

In another preferred embodiment of the subject invention, where the Terms of Sale (item d in the Transaction Information) indicates that the transfer of title is subject to a lien or other encumbrance (e.g., easements, reversionary interests, etc.) Controller 36 is programmed to automatically record such liens or other encumbrances in the updated title record.

Preferably, records tr will be stored in an encrypted and/or digitally signed form to avoid tampering.

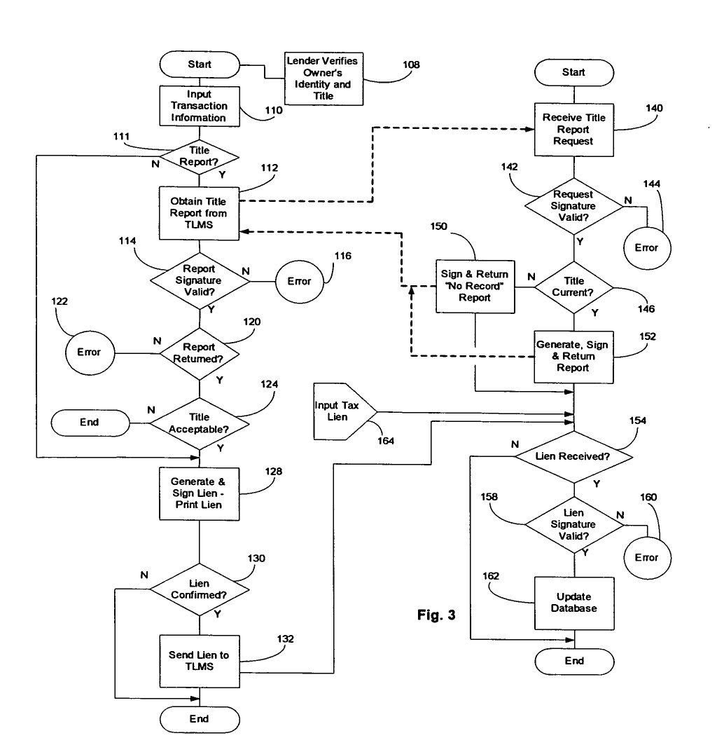

FIG. 3 shows a flow diagram of the operation of system 10 in creating a record of a lien on a particular item of property. Steps 110 through 132 show the operation of TSD 12, and steps 140 through 162 show the concurrent operation of TRMS 14. Assuming that TSD 12 has been initialized as described above, at step 108, a lender verifies the owner's (i.e., the last buyer's) identity in any convenient manner and verifies the owner's title to the identified item of property. Preferably, the owner's title document tn is read by TSN 12, using document reader 22 and is verified by:
a) verifying digital signatures on tn
b) confirming that machine readable and human readable information on document tn are consistent
c) inputting biometric characteristics of the owner through scanner 24 and confirming that they are consistent with biometric characteristics recorded on title document tn

In other embodiments of the subject invention, once a lender is satisfied as to the owner's identity, the owner's title can be confirmed by title report as described below.

Then at step 110, TSD 12 inputs transaction information relating to creation of a lien on an identified item of property. Typically, transaction information for a transfer of title can include:
a) Lender's Name(s) and Other Identifying Information
b) Owner's Name(s) and Other Identifying Information
c) Property Description/Identification
d) Terms of Lien
e) Date of Lien

In a preferred embodiment, this information can be input to controller 16 from one or more documents, which can include a seller's existing title document te, through document reader 22. In a preferred embodiment these documents are digitally signed with:
f) Lender's Digital Signature and Certificate
g) Owner's Digital Signature and Certificate
   which are verified by TSD 12.

Preferably, the transaction information will include:
h) Title Identification
   as described above.

Preferably, TSD-12 then augments the transaction information with:
i) Notary Name and Information
j) Notary ID; and
k) Transaction ID

In other embodiments of the invention, some or all of the above information is confirmed in any convenient manner by the notary and input manually through input 28.

At step 111, TSD 12 determines if a title report is needed. Typically, a lender will require a report if a new lien is to be created or the amount of an existing lien is to be increased but will not require a report if the amount secured is to be decreased or paid off. Such capability to vary the amount secured by a lien will be particularly useful for applications such as equity lines of credit where liens must be updated from time to time to reflect changes in the amount secured.

If a report is requested, then at step 112, controller 16 obtains a title report as will be described further below with respect to the operation of TRMS 14. At step 114, controller 16 confirms that the returned report is properly signed with signing key Sign _{CA} by TRMS 14, and, if not, goes to an error routine at step 116.

Then at step 60, controller 120 determines if a title report was returned by TRMS 14. If not, then controller 16 goes to an error routine at step 122. Otherwise, at step 124, controller 16 determines if the title is acceptable to complete the transaction. If not the program ends.

Then or if no report was requested at step 111, at step 128 TSD 12 generates, digitally signs, and prints a lien document which can include some or all of the transaction information described above in a two-dimensional barcode format, or any other convenient machine-readable format, to facilitate further transactions relating to that title. Then at 130, controller 16 determines if the lien transaction is confirmed, i.e., if the necessary formalities necessary to complete the transfer have been carried out. This determination can be made based on input by the notary who has witnessed the formal transfer or in any other convenient manner. If the transfer is not confirmed, the program ends. Otherwise, at step 72, controller 16 sends an updated, electronic lien document to TRMS 14. The program then ends.

At step 140 TRMS 14 receives a request for a title report generated by TSD 12 at step 112. The title can be identified by the unique title identification described above or can be identified by matching with other transaction information (e.g., seller's name, property description). Then at step 142, record system controller 36 determines if the request has been validly signed by TSD 12, and if not, goes to an error routine at step 144. Otherwise, at step 146, controller 36 determines if a current record of title is stored in title record store 38, and if not, then at step 150 generates and digitally signs a “No Record” report and returns it to TSD 12 at step 52.

Otherwise, at step 152, controller 36 generates, digitally signs, and sends an electronic copy of title report tr to TSD 12 at step 52. Preferably, report tr includes:
a) Title ID tr-1
b) Current Title Holder(s) tr-2
c) Last Title Transfer Date tr-3
d) Last Purchase Price tr-4
e) Current Assessed Value tr-5
f) List of Liens tr-6
g) Other Information as may be found useful tr-7
   Each listed lien preferably includes:
i) Transaction ID
ii) Lien ID
iii) Lien Amount/Description
iv) Lien Holder
v) Lien Date
   Controller 36 then digitally signs report tr before sending it to TSD 12.

Then at step 154, controller 36 determines if an electronic lien document is received from TSD 12. If because of a timeout condition or because TSD 12 sends a signal canceling the transaction in the course of an error routine, or for any other indication that the lien transaction will not be completed, controller 36 determines that the title will not change the program ends. Otherwise at step 158, controller 36 determines if the lien document has been validly signed by TSD 12, and if not, goes to an error routine at step 160. Otherwise at step 162, controller 36 updates the title record in accordance with the lien document.

In another embodiment of the subject invention, at step 164 Tax Authority 40 inputs a tax lien for taxes due or reduces the amount secured to reflect taxes paid through a direct link to TRMS 14 (shown in FIG. 1). Such tax liens are presumptively valid if found to be validly signed by Tax Authority 40 at step 158.

The embodiments described above and illustrated in the attached drawings have been given by way of example and illustration only. From the teachings of the present application those skilled in the art will readily recognize numerous other embodiments in accordance with the subject invention. Accordingly, limitations on the subject invention are to be found only in the claims set forth below.

What is claimed is:

1. A method for recording a transaction affecting title to an identified item of property, said method comprising the steps of:
a) inputting transaction information relating to said transaction to a title security device, said device storing a signing key for digitally signing documents;
b) controlling said device to generate a document representative of changes in said title resulting from said transaction; and
c) controlling said device to digitally sign said document with said signing key.

2. A method as described in claim 1 where said document is an electronic document.

3. A method as described in claim 1 where said document is a printed document.

4. A method as described in claim 1 where a copy of said document is provided to a tax authority.

5. A method as described in claim 4 where said device is controlled to compute a tax amount due with regard to said transaction and said document includes said amount.

6. A method as described in claim 5 where said device communicates with an escrow account system to cause said amount to be paid to said tax authority.

7. A method as described in claim 1 comprising the further step of sending a copy of said document to a title record management system.

8. A method as described in claim 7 comprising the further step of controlling said title record management system to verify said document's signature and update a record of title for said item of property in accordance with said document if said signature is determined to be valid.

9. A method as described in claim 1 comprising the further step of controlling said device to request and receive a copy of a record of title for said item and to provide at least one party to said transaction with information from said record of title before completion of said transaction.

10. A method as described in claim 1 where said document is a printed document, and said transaction is completed by signing of said document by at least one party to said transaction.

11. A method as described in claim 1 where said transaction includes transfer of title to said item of property.

12. A method as described in claim 1 where said transaction includes creation or updating of a lien against said item of property.

13. A method for maintaining a record of title for an item of property, said method comprising the steps of:
a) establishing a title record management system, said title record management system including a database, said database including an initial record for said item of property;
b) controlling said title record management system to receive a digitally signed document representative of changes in said title resulting from a transaction;
c) controlling said title record management system to verify said document's signature; and
d) controlling said title record management system to update said record of title for said item of property in accordance with said document if said signature is determined to be valid.

14. A method as described in claim 13 comprising the further steps, prior to step b of claim 13, of:
a) controlling said title record management system to receive a request for a copy of said record of title from a title security device; and
b) returning said copy to said device.

15. A method as described in claim 14 where said request is digitally signed and comprising the further steps of:
a) controlling said title record management system to verify said request's signature; and
b) controlling said title record management system to return said copy of said record of title only if said signature is determined to be valid.

16. A method as described in claim 13 where said transaction includes transfer of title to said item of property.

17. A method as described in claim 13 where said transaction includes creation or updating of a lien against said item of property.

18. A method as described in claim 13 where said document representative of changes in said title is generated by the steps of:
a) inputting transaction information relating to said transaction to a title security device, said device storing a signing key for digitally signing documents;
b) controlling said device to generate said document representative of changes in said title resulting from said transaction; and
c) controlling said device to digitally sign said document with said signing key.

19. A title security device for recording a transaction affecting title to an identified item of property, said device comprising:
a) input means for input of transaction information relating to a transaction to said title security device;
b) a data store storing a signing key for digitally signing documents;
c) a programmable controller communicating with a title record management system and programmed to control said title recording system to:
c1) input said transaction information;
c2) generate a document representative of changes in said title resulting from said transaction; and
c3) digitally sign said document with said signing key.

20. A title security device as described in claim 19 where said document is an electronic document.

21. A title security device as described in claim 19 further comprising a printer, and where said document is a printed document.

22. A title security device as described in claim 19 where said controller is programmed to compute a tax amount due with regard to said transaction, and said document includes said amount.

23. A title security device as described in claim 22 where said title recording system communicates with an escrow account system to cause said amount to be paid to a tax authority.

24. A title security device as described in claim 19 where said controller is programmed to send a copy of said document to said title record management system.

25. A title security device as described in claim 19 where said controller is programmed to print said document to reflect that said transaction is completed by signing of said document by at least one party to said transaction.

26. A title record management system for maintaining a record of title for an item of property, said system comprising:
a) a database, said database including an initial record for said item of property; and
b) a programmable record system controller communicating with a title security device and programmed to control said title record management system to:
b1) receive a digitally signed document representative of changes in said title resulting from a transaction;
b2) verify said document's signature; and
b3) update said record of title for said item of property in accordance with said document if said signature is determined to be valid.

27. A title record management system as described in claim 26 where said record system controller is further programmed to, prior to b1 in claim 26:
a) control said title record management system to receive a request for a copy of said record of title from said title security device; and
b) return said copy to said device.

28. A title record management system as described in claim 27 where said request is digitally signed and said record system controller is further programmed to:
a) control said title record management system to verify said request's signature; and
b) control said title record management system to return said copy of said record of title only if said signature is determined to be valid.

29. A system for recording a transaction affecting title to an identified item of property and for maintaining a record of title for said item of property, said system comprising:
a) a title security device; and
b) a title record management system; where
c) said title security device comprises:
c1) input means for input of transaction information relating to a transaction to said title security device;
c2) a data store storing a signing key for digitally signing documents; and
c3) a programmable controller communicating with said title record management system and programmed to control said title recording system to:
c3.1) input said transaction information;
c3.2) generate a document representative of changes in said title resulting from said transaction; and
c3.3) digitally sign said document with said signing key; and where
d) said title record management system comprises:
d1) a database, said database including an initial record for said item of property; and
d2) a programmable record system controller communicating with said title security device and programmed to control said title record management system to:
d2.1) receive a digitally signed document representative of changes in said title resulting from said transaction;
d2.2) verify said document's signature; and
d2.3) update said record of title for said item of property in accordance with said document if said signature is determined to be valid.
